(19) United States
(12) Patent Application Publication
(10) Pub. No.: US 2007/0209247 A1
(43) Pub. Date: Sep. 13, 2007

(54) Souvenir display device

(76) Inventors: David H. Raisner, West Hartford, CT (US); Barbara J. Raisner, Bonita Springs, FL (US)

Correspondence Address: CANTOR COLBURN, LLP, 55 GRIFFIN ROAD SOUTH, BLOOMFIELD, CT, 06002, US

(21) Appl. No.: 11/654,285

(22) Filed: Jan. 17, 2007

Related U.S. Application Data
(60) Provisional application No. 60/759,681, filed on Jan. 17, 2006.
(60) Provisional application No. 60/873,216, filed on Dec. 6, 2006.

(51) Int. Cl. A45C 1/00; G09F 3/00

(52) U.S. Cl. 40/323; 206/.8

(57) ABSTRACT

A souvenir display design is described comprising a transparent or translucent housing, the housing having at least one flattened surface for supporting the housing on a planar surface and a recess in a surface of the housing for frictionally receiving and engaging a souvenir. In another embodiment, the souvenir display comprises a keychain type configuration.

### CROSS-REFERENCE TO RELATED APPLICATION(S)

This application claims priority to Provisional U.S. Patent Application Ser. No. 60/759,681, filed Jan. 17, 2006, to David Raisner, et al. entitled SOUVENIR DISPLAY DEVICE and Provisional Patent Application Ser. No. 60/873,216 filed, Dec. 6, 2006 to David Raisner, et al. entitled SOUVENIR DISPLAY DEVICE, the entire contents of each of which are specifically incorporated by reference herein.

### BACKGROUND

This application relates generally to souvenir display devices. More particularly, this application relates to display devices, which are generally transparent or translucent and which receive therein souvenirs such as casino chips for easy display thereafter.

It is typical for consumers to purchase or receive souvenirs from vacations, holidays, trips and certain activities such as visits to casinos. Particularly, with respect to casinos, it is quite common to give as a gift or to take home one or more casino chips as a memento of the trip to the casino. In fact, many people routinely collect casino chips from various casinos as a memento or souvenir of their trip. Such casino chips and other souvenirs typically are placed on a table or in a drawer and are easily forgotten (as such souvenirs may be difficult to properly display).

### SUMMARY

The above-described and other problems and disadvantages of the art are overcome and alleviated by the present display device, which easily and efficiently stores a souvenir such as a casino chip for later display. An exemplary souvenir display device comprises a transparent or translucent plastic housing having a surface which includes an opening therein. The opening is sized and configured to allow the souvenir to be easily press fit (i.e., friction fit) therein. The housing also includes at least one flattened area so as to permit positioning of the housing on a flat surface such as a shelf or table. Because the housing is transparent or translucent, the souvenir is readably viewed from any side of the display device. Moreover, in the event that a different souvenir is desired to be placed in the display device, the friction fit will allow ease of removal of the souvenir with replacement of a different souvenir therein.

Another exemplary display device comprises a keychain type configuration.

The above-described display device is relatively inexpensive to manufacture and provides an easy cost-effective way of displaying a memento or other souvenir such as a casino chip.

The above-discussed and other features and advantages of the present invention will be appreciated and understood by those skilled in the art from the following detailed description and drawings.

### BRIEF DESCRIPTION OF THE DRAWINGS

Referring now to the exemplary drawings wherein like elements are numbered alike in the several FIGURES:

FIG. 1 is a front elevation view of an exemplary souvenir display device having a casino chip inserted therein in accordance with the present invention;

FIG. 2 is side elevation view of the display device of FIG. 1;

FIG. 3 is a bottom view of the display device of FIG. 1;

FIG. 4 is a perspective, exploded view of the display device of FIG. 1 showing the casino chip being inserted therein;

FIG. 5 is a front elevation view of another exemplary souvenir display device;

FIG. 6 is a side cross sectional view of the display device of FIG. 5;

FIG. 7 is a front perspective view of the display device of FIG. 5;

FIG. 8 is a rear perspective view of the display device of FIG. 5;

FIG. 9 is a perspective view of an exemplary display device;

FIG. 10 is a front schematic view of the exemplary display device of FIG. 9;

FIG. 11 is a side schematic view of the exemplary display device of FIG. 9;

FIG. 12 is a front perspective view of an exemplary display device;

FIG. 13 is a side schematic view of the exemplary display device of FIG. 12;

FIG. 14 is a front perspective view of an exemplary display device;

FIG. 15 is an exploded view of the exemplary display device of FIG. 14;

FIG. 16 is a front perspective view of an exemplary display device;

FIG. 17 is an exploded view of the exemplary display device of FIG. 16;

FIG. 18 is a front perspective view of an exemplary display device;

FIG. 19 is an exploded view of the exemplary display device of FIG. 18;

FIG. 20 is a front perspective view of an exemplary display device; and

FIG. 21 is a side schematic view of the exemplary display device of FIG. 20.

### DETAILED DESCRIPTION

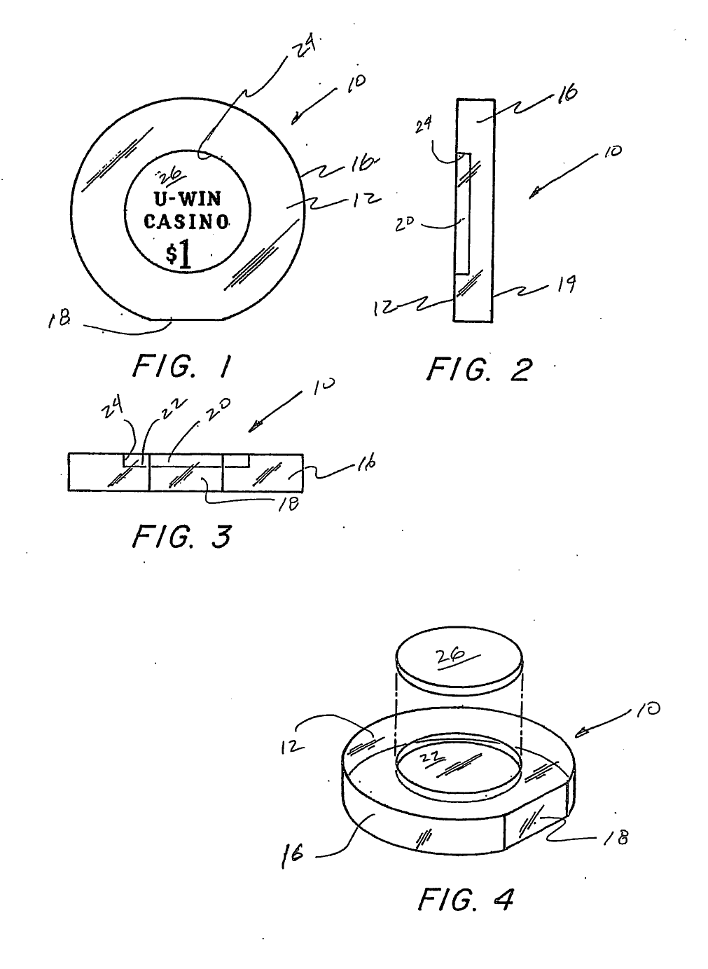

Referring to FIGS. 1-4, an exemplary display device for displaying a souvenir such as a casino chip is shown generally at 10. In this embodiment, the display device is shown having a cylindrical shape with a relatively circular front surface 12, a similarly shaped back surface 14 and a substantially cylindrical side surface 16 between front and back surfaces 12 and 14. A flattened support surface 18 is formed along a portion of cylindrical side surface 16. It will be appreciated that flattened support surface 18 provides a surface for display device 10 to be positioned on a table, shelf or other flattened surface for display of a souvenir.

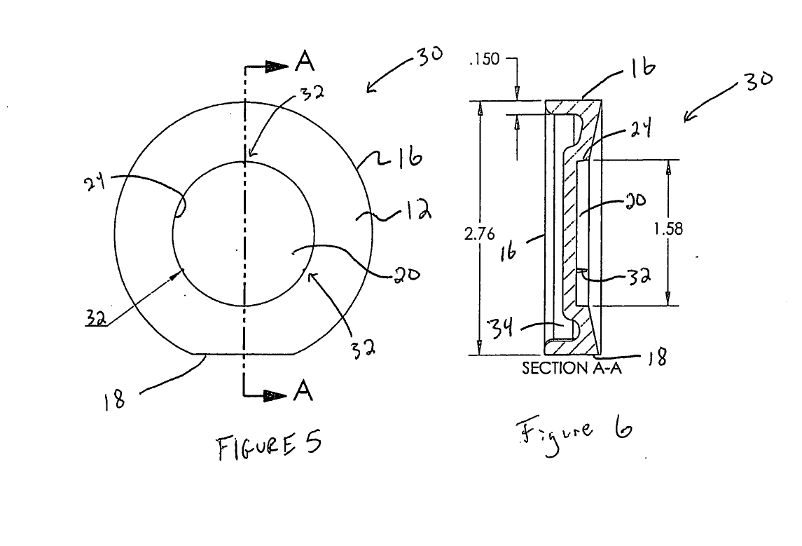

Front surface 12 includes a cylindrical opening 20 therein. In this embodiment, opening 20 is comprised of a circular base surface 22 and a cylindrical sidewall 24. Opening 20 is sized and configured to receive and frictionally engage with a souvenir such as a casino chip 26 shown in FIGS. 1 and 4. In other words, the diameter and circumference of opening 24 is sized and configured such that casino chip 26 may be received into the opening but because the opening is slightly smaller than casino chip 26, the chip will frictionally engage with and be retained by the sidewalls 24 of opening 20. An exemplary dimension for opening 22 is a diameter of about 1.5 inch and a depth of about 0.1406 ( 9/16) inch.

Display device 10 is of one-piece construction and preferably molded although the device could be machined from a single block of material. Display device 10 is made from a suitable polymeric material, which exhibits transparency and/or translucency, examples of which include acrylics or polycarbonates.

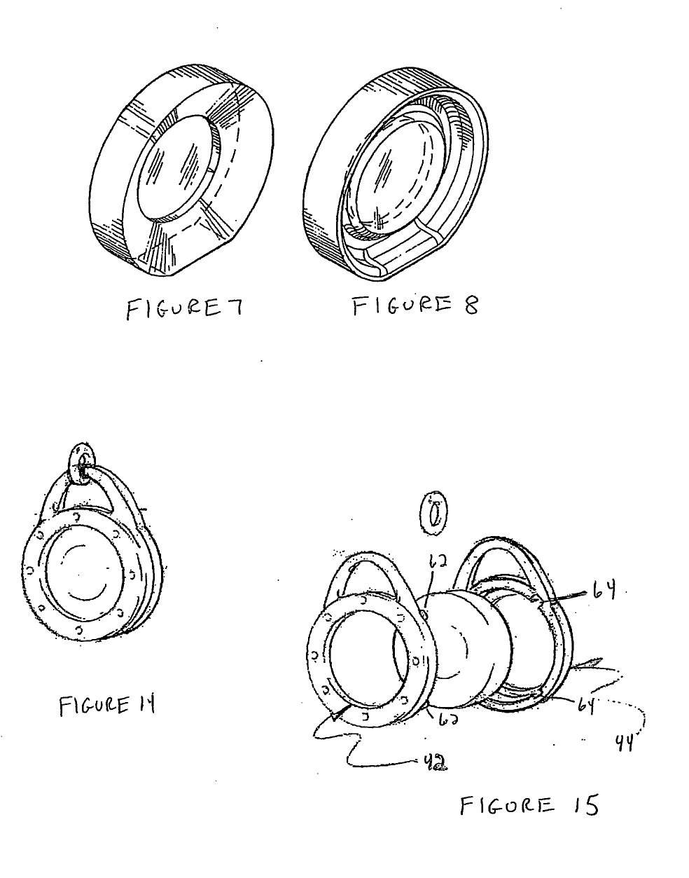

Referring now the FIGS. 5 and 6, another exemplary display device is illustrated generally at 30. In this embodiment, the display device is shown having a cylindrical shape with a relatively circular front surface 12, a similarly shaped back surface 14 and a substantially cylindrical side surface 16 between front and back surfaces 12 and 14. A flattened support surface 18 is formed along a portion of cylindrical side surface 16. It will be appreciated that flattened support surface 18 provides a surface for display device 10 to be positioned on a table, shelf or other flattened surface for display of a souvenir. FIGS. 7 and 8 show front and rear perspective views of the exemplary device of FIGS. 5 and 6.

Front surface 12 includes a cylindrical opening 20 therein. In this embodiment, opening 20 is comprised of a circular base surface 22 and a cylindrical sidewall 24. Opening 20 is sized and configured with one or more ribs 32 to receive and frictionally engage with a souvenir such as a casino chip 26 shown in FIGS. 1 and 4. In other words, the diameter and circumference of opening 24 is sized and configured, and the at least one rib is formed therein, such that casino chip 26 may be received into the opening but because the inner circumference of the opening 20 with rib(s) 32 is slightly smaller than casino chip 26, the chip will frictionally engage with and be retained by the rib(s) 32 of opening 20. An exemplary dimension for opening 22 is a diameter of about 1.58 inch and a depth of about 0.1406 ( 9/16) inch. An exemplary dimension for each of three exemplary crush ribs on the sidewall 24 of the opening is about 0.03 inches protrusion from the sidewall 24.

Display device 10 is of one-piece construction and preferably molded although the device could be machined from a single block of material. Display device 10 is made from a suitable polymeric material, which exhibits transparency and/or translucency, examples of which include acrylics or polycarbonates. Referring to FIG. 6, to save materials and weight (and thus cost), the front side 12 of the display device 10 may be beveled from the outer circumference to the opening 20. Also, a void 34 may be formed in the backside 16 of the display device, either or both of behind the opening 20 and behind the device 20 but outside the circumference of the opening 20. Also, as illustrated, the relative volume of void space may differ across the display device, with the exemplary display device of FIG. 6 having more volume removed in the outer periphery of the device back 16, and less removed behind the opening 20. The void may be formed by a molding process when making the device, machined after making the device, or the equivalent. In the illustrated exemplary embodiment, the void space creates a peripheral sidewall having about 0.15 inches of thickness on a display device that measures about 2.76 inches from top to bottom. Again, these dimensions are merely exemplary and not limiting.

While the embodiments shown in FIGS. 1-8 have an overall generally cylindrical configuration, it will be appreciated that this is an example only. In fact, display device 10 may have any suitable overall configuration such as a square, rectangle or any other geometric shape including symmetric or asymmetric geometries. Further, it will be appreciated that while the embodiment shown in FIGS. 1-4 is sized to receive a coin-type souvenir (such as a casino chip) the opening 20 may be similarly configured to receive any other suitable souvenir such as a souvenir having a square, rectangular or other geometric shape, whether symmetrical or asymmetrical. It will also be appreciated that flattened surface 18 may have a variety of configurations and may include additional layers adhesively or otherwise applied thereto, such as a felt or fabric covering.

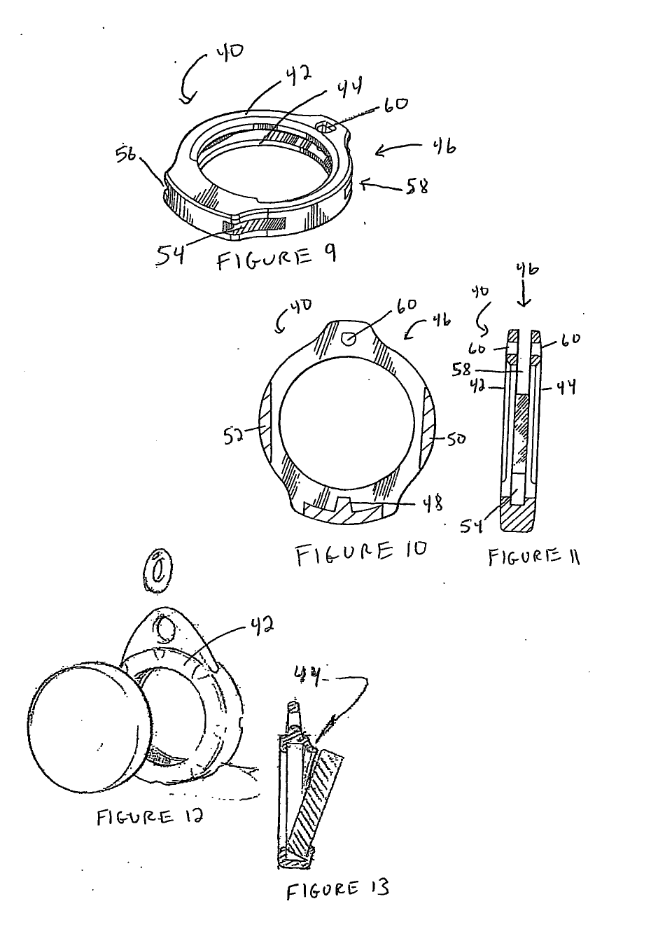

Referring now to FIGS. 9-11, another exemplary display device is illustrated generally at 40. This embodiment is of a key chain or FOB type, wherein the souvenir (not shown) will insert between front and rear faces 42, 44 through a top portion, shown generally at 46. When inserted, the souvenir will be supported by at least one supporting interior contour (i.e., either conforming to the shape of the souvenir or having multiple points of contact (48, 50, 52 in FIG. 10) to allow space around the souvenir, e.g., to at least some of the sides of the souvenir for viewing (see openings 54, 56, 58 in FIGS. 9-11)). An opening 60 is provided through one or both of the front and rear 42, 44 of the device to accommodate a key chain or the like. In the presently illustrated exemplary embodiment, it is noted that something inserted through one of the openings 60 would effectively prevent the souvenir from sliding out of the device. In an exemplary embodiment, the display device is not more than twice the diameter of the souvenir. In another exemplary embodiment, the device is not more than 1.5 times the diameter of the souvenir. In another exemplary embodiment, the device is not more than 1.1 times the diameter of the souvenir.

Of course, any portion of the device may have tackiness or be configured to frictionally engage the souvenir to resist movement of the souvenir in an installed configuration.

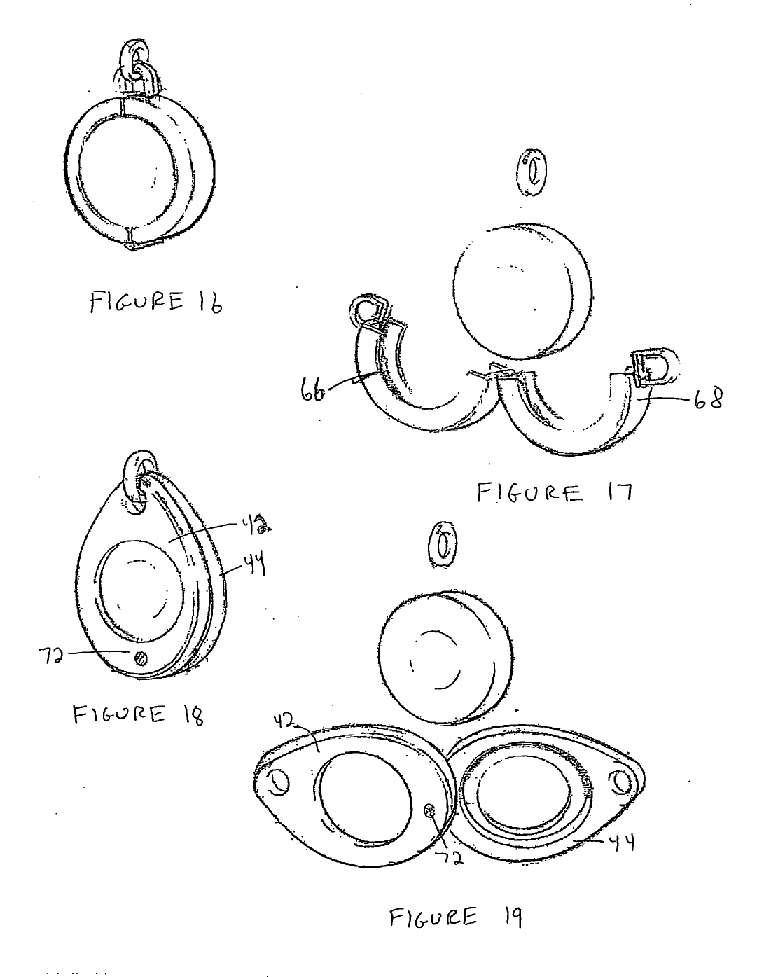

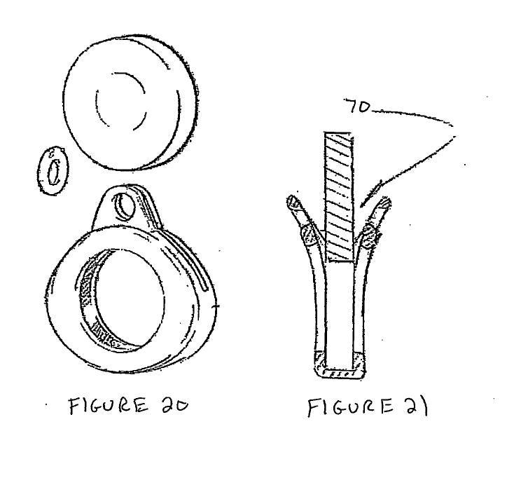

Referring now to FIGS. 12 and 13, another exemplary embodiment allows for deformation of a part of the display device (in the illustrated case, at least a portion of the back surface 44) to accommodate the souvenir. Referring now to FIGS. 20 and 21, another exemplary embodiment allows for deformation of a part of the display device (in the illustrated case, spreading of an upper region 70 of the device) to accommodate the souvenir.

Referring now to FIGS. 14 and 15, another exemplary embodiment allows for disassembly and reassembly of a part of the display device (in the illustrated case, disassembly of the front surface 42 from the back surface 44) to accommodate the souvenir. This embodiment may include any of various mechanisms to resist detaching of the pieces when assembled, including snap fits or other mechanical locks (see snap fit portions 62 configured to mate with recesses 64), among others. FIGS. 16 and 17 illustrate another such embodiment, wherein two portions 66, 68 are hingedly attached. FIGS. 18 and 19 illustrate another exemplary embodiment that allows for disassembly and reassembly of a part of the display device (in the illustrated case, a different kind of hinged relationship, where front and back surfaces 42, 44 include a hinge 72 therebetween) to accommodate the souvenir.

While exemplary embodiments have been shown and described, various modifications and substitutions may be made thereto without departing from the spirit and scope of the invention. Accordingly, it is to be understood that the present invention has been described by way of illustration and not limitation.

What is claimed is:

1. A souvenir display comprising:
a transparent or translucent housing, said housing having at least one flattened surface for supporting said housing on a planar surface;
a recess in a surface of said housing for frictionally receiving and engaging a souvenir.

2. The device of claim 1 wherein:
said housing is substantially cylindrical.

3. The device of claim 1 wherein:
said recess is cylindrical.

4. The device of claim 2 wherein:
said recess is cylindrical.

5. The device of claim 1 wherein:
said recess is sized to receive a casino chip.

6. The device of claim 1 wherein:
said recess comprises at least one rib on an inner wall thereof, and wherein said at least one rib frictionally receives and engages a souvenir.

7. The device of claim 6 wherein:
said recess comprises three crush ribs spaced along the inner wall thereof.

8. The device of claim 1 wherein:
a front side of said housing has a surfaced that is beveled from an outer periphery to said recess.

9. The device of claim 1, further comprising:
a void formed on the back side of said housing.

10. The device of claim 9 wherein:
said void is formed behind said recess.

11. The device of claim 9 wherein:
said void is formed outside the circumference of said recess.

12. The device of claim 9 wherein:
said void is formed both behind said recess and outside the circumference of said recess.

13. The device of claim 12 wherein:
said void volume varies in at least two areas of said housing rear side.

14. A souvenir display comprising:
an outer surface having an inner cavity configured to at least partially contain a souvenir and configured to hold the souvenir therein, the display having a front and a rear aperture for displaying a front and a rear side of the souvenir.

15. The device of claim 14, wherein display device is not more than twice the diameter of the souvenir.

16. The device of claim 14, wherein the device is not more than 1.5 times the diameter of the souvenir.

17. The device of claim 14, wherein the device is not more than 1.1 times the diameter of the souvenir.

18. The device of claim 14, wherein the device includes at least one side aperture exposing a side of the souvenir to view.

19. The device of claim 14, wherein at least a portion of the device is deformable.

20. The device of claim 14, wherein at least a portion of the device comprises a plurality of assembled pieces.

21. The device of claim 20, wherein at least two of said pieces are detachable.

22. The device of claim 20, wherein at least two of said pieces are connected by a hinge.
